(19) United States
(12) Patent Application Publication
(10) Pub. No.: US 2011/0253708 A1
(43) Pub. Date: Oct. 20, 2011

(54) Device for heating plastic containers and resonator therefor

(75) Inventors: Johann Zimmerer, Bernhardswald (DE); Konrad Senn, Regensburg (DE); Guenter Winkler, Zell (DE); Andreas Apelsmeier, Regensburg (DE)

(73) Assignee: KRONES AG, Neutraubling (DE)

(21) Appl. No.: 13/131,865

(22) PCT Filed: Dec. 1, 2009
(86) PCT No.: PCT/EP2009/066091

§ 371 Date: Jul. 7, 2011

(30) Foreign Application Priority Data
Dec. 4, 2008 (DE) 10 2008 060 572.7

(51) Int. Cl. H05B 6/72

(52) U.S. Cl. 219/761

(57) ABSTRACT

The invention relates to a device (1) for heating plastic preforms (10), comprising at least one microwave generator (2) that generates an alternating electromagnetic field in the form of microwaves, a microwave transmission unit (4) that transmits the microwaves generated by the microwave generator (2) to a resonator unit (6), and a conveying device that conveys the plastic preforms (10) to the resonator unit (6), wherein the resonator unit (6) comprises a resonator housing (8) that forms a receptacle space (10) for heating the plastic preforms (10), said housing having at least one inner wall (22a, 22b, 22c) facing the plastic preforms (10) and an injection area (12) through which the microwaves are introduced into the resonator unit (6), wherein the inner wall (22a, 22b, 22c) is annealed on the surface thereof facing the plastic preforms at least in some sections such that the annealing reduces power losses in the inner wall caused by the microwaves.

The present invention relates to an apparatus and a method of heating plastics material containers and, in particular plastics material pre-forms. In the field of the beverage production industry, there has been an increasing move to use plastics material containers or PET containers instead of glass bottles. During the production of these containers, plastics material pre-forms are first made available, and they are heated and passed on to an expansion process in order to obtain the finished plastics material containers in this way. In this case it is customary in the prior art to have the plastics material pre-forms pass through a heating path, inside which they are usually heated by infrared radiation.

In addition, however, it is also known from the prior art to use microwave radiation in order to heat the plastics material pre-forms. In this case the microwave radiation is generated by a microwave generation device, such as a magnetron, and is then transmitted by way of a transmission device, such as a wave guide, to the plastics material pre-forms to be heated. The microwave energy reaching the pre-forms can be controlled by means of tuning units. In this case the power applied to the plastics material pre-forms is usually set before starting up the apparatus and the apparatus is then operated at this fixed power.

In this way, in order to heat them, the pre-forms are acted upon in a resonator with an electromagnetic alternating field which, however, also produces an excitation of the dipoles in the interior of the material, and this in turn results in heating of the pre-forms.

A heating apparatus for plastics material blanks is known from DE 10 2007 022 386 A1. In this case the region of the pre-forms to be heated is acted upon in a resonator with microwaves during at least part of the duration of the heating.

DE 10 2006 015 475 A1 likewise describes a method and an apparatus for the tempering of pre-forms. In this method, use is made of cylindrically designed resonators which display relatively high wall current losses in their design.

The object of the present invention is therefore to increase the efficiency of heating devices of this type and, in particular, to reduce losses for heating devices of this type.

This is achieved according to the invention by the subjects of the independent claims. Advantageous embodiments and further developments form the subject matter of the subclaims.

An apparatus according to the invention for the heating of containers and, in particular of plastics material pre-forms, has at least one microwave production unit which produces an electromagnetic alternating field in the form of microwaves. In addition, a microwave transmission unit is provided, which transmits the microwaves produced by the microwave production device to a resonat[or] unit as well as a conveying unit which conveys the plastics material pre-forms with respect to the resonator unit. In this case the resonator unit has a resonator housing forming a receiving space for heating the plastics material pre-forms and having at least one inner wall facing the plastics material pre-forms as well as a coupling-in area by way of which microwaves are introduced into the resonator unit.

According to the invention the inner wall is treated (for heat-treating, or polishing or coating or annealing) at least locally on its surface facing the plastics material pre-forms, in such a way that as a result of this treatment in the inner wall the wall current losses caused by the microwaves are reduced.

It is therefore proposed according to the invention to design the aforesaid inner wall or the surface thereof in a pre-determined manner which will reduce the wall current losses. In this case a treatment may be a treatment such as a polishing of the wall, but also a deliberate texturing and also combinations of these measures. This is explained in greater detail below.

It is preferable for the inner wall to be polished in order to reduce the surface roughness thereof.

A problem which arises from the dielectrical loss factor of current materials for plastics material pre-forms such as for example PET is the very high field strength which is present in the resonator or is required for heating. This strong field enhancement, which is necessary for a rapid heating, leads however to a high wall current in the conductive resonator wall and also in the walls of the microwave supply lines. On account of the high frequency the aforesaid wall currents flow only in a thin surface layer, this also being known as a skin effect.

The concept according to the invention consists in keeping as small as possible the losses which occur as a result of these wall currents, so as thus to improve the entire process in terms of energy. In this way it is possible for example for the aforesaid surfaces to be polished. Since the current path is increased by the above-mentioned surface roughness, the loss also increases as the roughness increases. It is preferable for the aforesaid inner wall, i.e. the polished inner wall, to have a surface roughness which is less than 3 μm, preferably less than 2 μm and in a particularly preferred manner less than 1 μtm. The surface roughness should generally be lower and preferably considerably lower than the depth of penetration δ of the microwave, i.e.:

Rₘₐₓ<<δ

In the case of aluminium and at a frequency of 2.45 GHz, Rₘₐₓ should be less than 1 μm. It is preferable for the inner wall to have a polished or precision-milled surface.

In the case of a further preferred embodiment the inner wall is formed from a carrier material and a coating provided on the surface of this carrier material which faces the plastics material pre-forms, this coating having a higher electrical conductivity than the carrier material. In the prior art the aforesaid inner walls of the resonators are usually made in one piece or non-coated, i.e. they have no special coating. The carrier material can be for example a block of aluminium. In addition, the aforesaid carrier material can be galvanically silver-plated or copper-plated for example.

Since the aforesaid current flows only through a thin layer, the resistance and thus also the loss can be reduced by the application of a highly conductive layer. It is preferable for the layer thickness D also to be greater than the above-mentioned depth of penetration δ. In this way, the following can apply:

1 mm>>D>δ.

This coating thus ensures that a current flows only in the aforesaid conductive layer. It would also be possible for the entire resonator to be produced in a solid manner from a highly conductive material such as for example from copper.

In the case of a further preferred embodiment the resonator housing is formed in a multiplicity of parts. The design of the resonator in a multiplicity of components has advantages in terms of production. In addition, as a result of this multiple-part design of the resonator housing and thus for example also of the inner wall, the aforesaid current losses can be reduced. It is preferable for a plurality of parts of the resonator first to be produced, then to be joined together and finally to be coated with an—in particular one-piece—metallic layer which covers the individual cuts.

In the case of a further advantageous embodiment the resonator housing is capable of being divided. This is particularly advantageous since the resonator can also be opened subsequently. On the other hand, division lines of this type can result in higher current losses inside the resonator. In this case it is preferable for the resonator housing to be designed in such a way that division lines, in particular division lines inside the inner walls, extend substantially parallel to the flow direction of the wall currents. In this way, as indicated in greater detail below, the flow losses can be likewise reduced.

In the case of a further advantageous embodiment the inner wall has a texturing in a direction extending parallel to a direction of the current produced by the microwaves in the inner wall. This texturing can be for example the above-mentioned cuts which are necessary for the two-part design of the housing. It would also be possible, however, for a corrugated or prong-like structure with recesses and depressions to be provided, these recesses and depressions extending parallel to the direction of flow of the wall currents.

The overall resistance of the inner wall is dependent upon the surface resistance RF with respect to a length l (parallel to the direction of flow) of the current path and a width b (which is at a right angle to the direction of flow) and can be described as follows:

R=R_{F}*l/b.

In order to reduce this current or the resistance thereof, it is therefore possible to form waves or prongs in the surface parallel to the flow direction, in order increase the aforesaid width b artificially in this way and thus to reduce the resistance. In this case it is also possible to combine the measures described above, for example a coating with the specified texturing or even a polished surface with the specified texturing and, in addition, also the specified cuts parallel to the direction of the current flow.

It would also be possible, however, for the resonator to be designed in one piece. In this case it is possible for a metallic layer to be deposited electrogalvanically on a negative of plastics material and then to remove the negative chemically. It would also be possible, however, for the resonator to be produced by cutting from one piece by using a special tool.

It is preferable for the specified texturing to be produced in the form of waves and/or prongs.

If it is impossible to prevent—on grounds of costs or production in particular embodiments—a cut not being positioned parallel to the current flow, then a groove can be provided in this cut on the inside. This groove reduces the abutment face of a screw fastening and in this way increases the contact pressure. On account of the contact pressure the two faces rest against each other in an improved manner, as a result of which the aforesaid cut is minimized and in this way the resistance is reduced.

As a result of each of the specified measures, the electrical resistance of the inner wall can thus be reduced, in particular in the flow direction of the wall currents, as compared with embodiments without any treatment. In addition, the design of the above-mentioned cuts parallel to the flow direction of the current constitutes a measure for the treatment of the inner wall, in particular for multiple-part resonator housings, in this context.

Further advantages and embodiments may be seen from the accompanying drawings. In the drawings

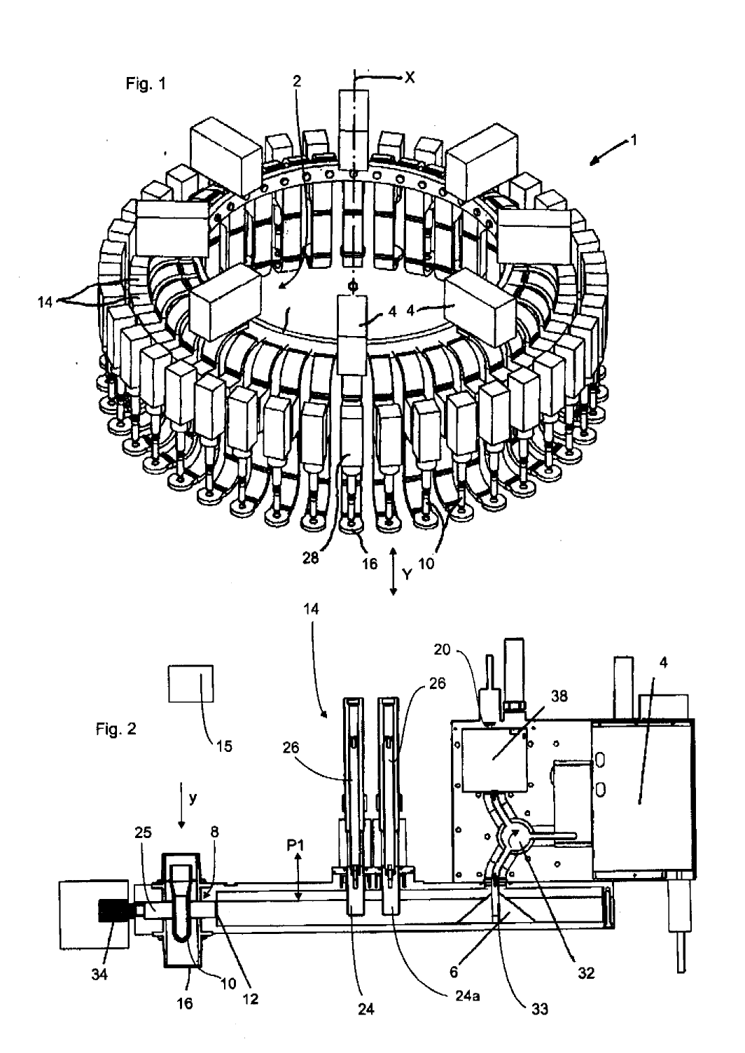

FIG. 1 is a diagrammatic illustration of an apparatus for the heating of containers;

FIG. 2 is a diagrammatic illustration of an apparatus according to the invention in a first embodiment;

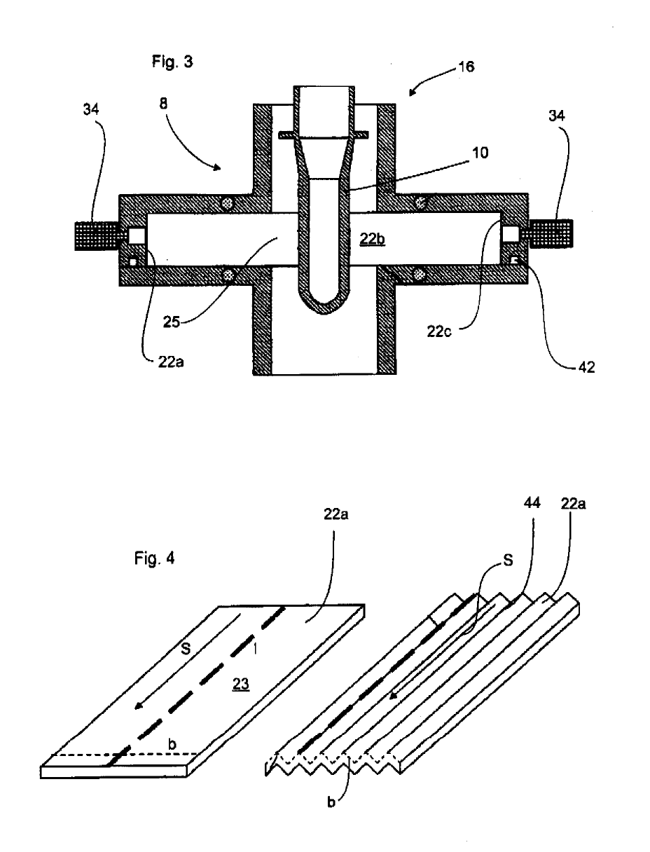

FIG. 3 is a diagrammatic illustration of a resonator for the apparatus as shown in FIG. 2, and

FIG. 4 is an illustration of an inner wall for a preferred embodiment of the invention.

FIG. 1 shows an apparatus 1 for the heating of containers or plastics material pre-forms 10. In this case the apparatus 1 has a plurality of microwave production devices 4, the microwaves produced by these microwave production devices 4 arriving at resonators 16 by way of duct devices and being introduced from these resonators 16 into containers 10 which in this case are pre-forms. The apparatus can also, however, be used for heating already finished plastics material containers.

In this case the reference number 2 relates to a conveying device which has the effect that the individual containers are rotated about an axis of rotation X. The reference number 14 relates in its entirety to energy determination units which regulate the energy applied to the containers. With the aid of drive devices 28 the position of the containers 10 can be shifted with respect to the resonators 16 in the direction Y which extends parallel to the axis of rotation X.

FIG. 2 shows an apparatus 1 according to the invention in a first embodiment. This apparatus has a magnetron 4 into which a heating device (not shown) is already incorporated. The microwaves are produced in this magnetron 4 and are directed into a circulator 32. Starting from this circulator the microwaves are introduced with the aid of a coupling-in device 33 into a duct device 6 in the form of a microwave guide or a rectangular wave guide. From there the microwaves pass by way of a coupling-in region into a resonator 16 or the containers 10 arranged inside this resonator. In this case the containers 10 are inserted into the resonator 16 in the direction of the arrow P1.

The reference number 34 relates to a temperature sensor and, in particular, a pyrometer, which is arranged on the resonator 16 and measures without contact the temperature of the pre-forms 10. The microwaves returning from the pre-forms pass in turn into the circulator and from there into a water load 38. This water load 38 is used for damping the microwaves. The returning microwave energy can be measured with the aid of a sensor device 20 in the form of a diode.

The measured values are in turn received by a control device 15 and are used to determine the performance. It would also be possible, however, in order to determine the performance or energy, for the values emitted by the pyrometer 34 to be used in addition to or instead of the values measured by the sensor device. In addition, the pyrometer could also be used for changing the heating phase.

The reference number 14 relates in its entirety to an energy determination unit which in this case has two drives 26 in the form of linear motors. In addition, the energy determination unit 14 has two regulating members or tuning pins 24, 24a, the position of which can be altered with respect to the wave guide 6 in the direction of the arrow P1. During the current operation, i.e. the current heating of the containers, the control device 15 alters if necessary the position of the regulating member 24 with respect to the rectangular wave guide and thus regulates the microwave energy applied to the container. In the case of apparatus known from the prior art, at least three regulating members are provided in part. In the embodiments proposed in this case, however, two regulating members of this type are also sufficient.

As mentioned, the container 10 is arranged at least locally in the resonator unit 16, in order to be heated there. In this case the resonator unit 16 has a housing 8 inside which a cavity 25 is formed. In addition, the resonator housing 8 has inner walls in each case, which face the pre-form.

FIG. 3 is a detailed illustration of the resonator unit 16. It is evident that this resonator unit 16 has a plurality of inner walls, of which only the inner walls 22a, 22b and 22c are shown here and which bound the above-mentioned cavity 25 or receiving space for the containers. In this case this receiving space need not be closed off completely. Inside these inner walls the current losses which occur as a result of the microwave stressing should be reduced. The microwaves pass by way of an inlet region 12 (cf. FIG. 2) into the resonator unit 16.

The reference numbers 34 relate to temperature sensors which determine the temperature in the interior of the resonator 16, i.e. in particular in the cavity 25.

It is evident that the housing 8 is constructed in two parts in this case. The reference number 42 relates to a groove which is situated in one of the two housing parts. On account of this groove 42 the contact pressure between the two housing parts can be increased, since the groove 42 reduces the abutment face of the screw fastening. In this way, the current resistance is reduced.

FIG. 4 is an illustration of a wall 22a. In this case the reference letter L relates to a length direction inside the wall 22a and the reference letter S to a direction of the current flow. In this way, the current produced by the microwaves in the walls flows along the line S. In the right-hand part of the illustration of FIG. 4 this wall 22a has a corrugated shape, i.e. a plurality of prongs 44. In this way, an extension of the wall 22a is enlarged in the direction b shown in FIG. 4 and, as mentioned above, the aforesaid width b is increased in this way and the resistance is reduced in this way. The reference number 23 designates the surface of the wall.

In addition, the wall 22a can also have a coating of a good current-conducting material, in particular silver or copper, in order to reduce current losses in this way, as mentioned above. The surface 23 of the wall can also be polished, as mentioned in the introduction. The measures mentioned for the treatment of the surfaces can also be used on an inner wall of the duct device or the wave guide 6.

All the features disclosed in the application documents are claimed as being essential to the invention, insofar as they are novel either individually or in combination as compared with the prior art.

1. An apparatus (1) for the heating of containers and, in particular of plastics material pre-forms (10), with at least one microwave production unit (4) which produces an electromagnetic alternating field in the form of microwaves, a microwave transmission unit (6) which transmits the microwaves produced by the microwave production unit (4) to a resonator unit (16), and with a conveying device which conveys the plastics material pre-forms (10) with respect to the resonator unit (16), wherein the resonator unit (16) has a resonator housing (8) forming a receiving space (25) for heating the plastics material pre-forms (10) and having at least one inner wall (22a, 22b, 22c) facing the plastics material pre-forms (10) and a coupling-in area (12) by way of which the microwaves are introduced into the resonator unit (16), wherein the inner wall (22a, 22b, 22c) is treated at least locally on its surface facing the plastics material pre-forms (10), in such a way that, as a result of this treatment in the inner wall, wall current losses caused by the microwaves are reduced.

2. The apparatus according to claim 1, wherein the inner wall (22a, 22b, 22c) is polished in order to reduce the surface roughness thereof.

3. The apparatus according to claim 2, wherein the inner wall (22a, 22b, 22c) has a surface roughness which is less than 3 μm, preferably less than 2 μm and in a particularly preferred manner less than 1 μm.

4. (canceled)

5. The apparatus according to claim 4, wherein a layer thickness d of this coating is greater than a depth of penetration of the microwaves.

6. The apparatus according to claim 1, wherein the resonator housing (8) is formed in a multiplicity of parts.

7. The apparatus according to claim 6, wherein division lines of the resonator housing formed in a multiplicity of parts extend substantially parallel to the flow direction (S) of the wall currents.

8. The apparatus according to claim 1, wherein the inner wall (22a, 22b, 22c) has a texturing in a direction extending parallel to a direction (S) of the current produced by the microwaves in the inner wall (22a, 22b, 22c).

9. The apparatus according to claim 6, wherein the texturing is produced in the form of waves and/or prongs.

10. The apparatus according to claim 1, wherein the inner wall (22a, 22b, 22c) is formed from a carrier material and a coating provided on the surface of this carrier material which faces the plastics material pre-forms, wherein this coating has a higher electrical conductivity than the carrier material.

11. The apparatus according to claim 2, wherein the inner wall (22a, 22b, 22c) is formed from a carrier material and a coating provided on the surface of this carrier material which faces the plastics material pre-forms, wherein this coating has a higher electrical conductivity than the carrier material.

12. The apparatus according to claim 3, wherein the inner wall (22a, 22b, 22c) is formed from a carrier material and a coating provided on the surface of this carrier material which faces the plastics material pre-forms, wherein this coating has a higher electrical conductivity than the carrier material.
